(19) United States
(12) Patent Application Publication
(10) Pub. No.: US 2011/0088151 A1
(43) Pub. Date: Apr. 21, 2011

(54) FIREFIGHTER'S TURNOUT COAT WITH SEAMLESS COLLAR

(76) Inventors: Semra Peksoz, Stillwater, OK (US); Donna Branson, Stillwater, OK (US); Vincent Gil Vargas Quevedo, Stillwater, OK (US); Tricia L. Hock, Newark, OH (US); John M. Karban, Chesterfield, OH (US); Stacy L. Boland, Seville, OH (US); James J. Cabot, Brook Park, OH (US)

(21) Appl. No.: 11/736,299

(22) Filed: Apr. 17, 2007

(51) Int. Cl. A62B 17/00; A41D 3/02

(52) U.S. Cl. 2/458; 2/98

(57) ABSTRACT

A firefighter's turnout coat comprising a coat body having a collar extending therefrom wherein the coat body and the collar each comprise an outer shell, a thermal liner, and a moisture barrier positioned between the outer shell and the thermal liner. The collar of the coat is an integral extension of the coat body such that there is no stitched collar seam connecting the collar to the coat body.

### FIELD OF THE INVENTION

The present invention relates to firefighters' turnout coats.

### BACKGROUND OF THE INVENTION

Firefighters' turnout coats typically comprise four layers of material. As is known in the art, the two outermost layers are outer shell layers, each of which is typically formed of flame resistant fabric comprising, for example, aramid, para-aramid, PBI, and/or P84 fiber or fiber blends. The innermost layer is a thermal liner which is typically formed of quilted fabric comprising, for example, a woven flame resistant fabric quilted to a batting of an aramid and para-aramid fiber blend.

The fourth layer of a typical turnout coat is a moisture barrier positioned between the outer shell and the thermal liner. The moisture barrier typically comprises, for example, a breathable membrane laminated to a lightweight flame resistant woven fabric or batting. The lining system of the turnout coat comprising the thermal liner and the moisture barrier is typically removable from the outer shell for laundering.

The National Fire Protection Association, a consensus standards writing organization, requires that all firefighters' coats be constructed with a collar that stands upright to a required height. Heretofore, the collar, which typically comprises four layers of material (two outer shell layers, a thermal liner, and a moisture barrier) in the same manner as the body of the coat, has been constructed as a separate piece which has been attached to the coat body by a stitched seam.

A need exists for a more watertight collar system for a firefighter's turnout coat to prevent leakage during use and to provide more continuous, uniform, and uncompromised thermal and flame resistance properties throughout the entire collar area.

### SUMMARY OF THE INVENTION

The present invention provides an improved firefighter's turnout coat having a seamless collar which addresses the needs discussed above. An unintended consequence of the prior art technique of attaching the collar to the coat body using a stitched seam is that the penetration of the stitching needle during the sewing process also creates numerous small holes through the fabric layers. By eliminating this stitched seam, the present invention prevents leakage which would otherwise occur through the holes formed by needle presentation. Such needle penetration is particularly damaging to the inner moisture barrier of the turnout coat even though the stitching is seam sealed for protection. The seamless collar system of the inventive firefighter's turnout coat thus significantly reduces the chances for thermal or burn injuries and also increases the life of the coat.

The present invention provides an improved firefighter's turnout coat. The firefighter's turnout coat comprises a coat body having a collar extending therefrom which will stand upright during use. The coat body and the collar each comprise an outer shell, a thermal liner, and a moisture barrier between the outer shell and the thermal liner. The inventive improvement to the firefighter's coat comprises the collar being an integral extension of the coat body such that there is no stitched collar seam connecting the collar to the coat body.

In another aspect, the inventive improvement to the firefighter's turnout coat preferably also comprises the outer shell comprising a body portion and a collar portion which is an integral extension of the body portion of the outer shell such that there is no stitched collar seam connecting the collar portion of the outer shell to the body portion of the outer shell.

In another aspect, the inventive improvement to the firefighter's turnout coat preferably further comprises the moisture barrier comprising a body portion and a collar portion which is an integral extension of the body portion of the moisture barrier such that there is no stitched collar seam connecting the collar portion of the moisture barrier to the body portion of the moisture barrier.

In another aspect, the inventive improvement to the firefighter's turnout coat preferably further comprises the thermal liner comprising a body portion and a collar portion which is an integral extension of the body portion of the thermal liner such that there is no stitched collar seam connecting the collar portion of the thermal liner to the body portion of the thermal liner.

Further aspects, features, and advantages of the present invention will be apparent to those of ordinary skill in the art upon examining the accompanying drawings and upon reading the following detailed description of the preferred embodiments.

### BRIEF DESCRIPTION OF THE DRAWINGS

FIG. 1 is a closed front view of an embodiment 2 of the inventive improved firefighter's turnout coat.

FIG. 2 is an open front view of the inventive turnout coat 2.

FIG. 3 is an open side view of the inventive turnout coat 2.

FIG. 4 is a back view of the inventive turnout coat 2.

FIG. 5 is a cutaway view of the inventive turnout coat 2 showing two outer shell layers 3 and 4, an inner thermal lining layer 6, and a moisture barrier layer 8 positioned between the outer shell layer 4 and the thermal liner 6.

FIG. 6 shows the fabric patterns used for forming each of the outer shell layer 4, the thermal liner layer 6, and the moisture barrier layer 8 of the inventive turnout coat 2.

FIG. 7 further illustrates the shell 5, thermal liner 6, and moisture barrier 8 layers of the inventive coat and collar.

### DETAILED DESCRIPTION OF THE PREFERRED EMBODIMENTS

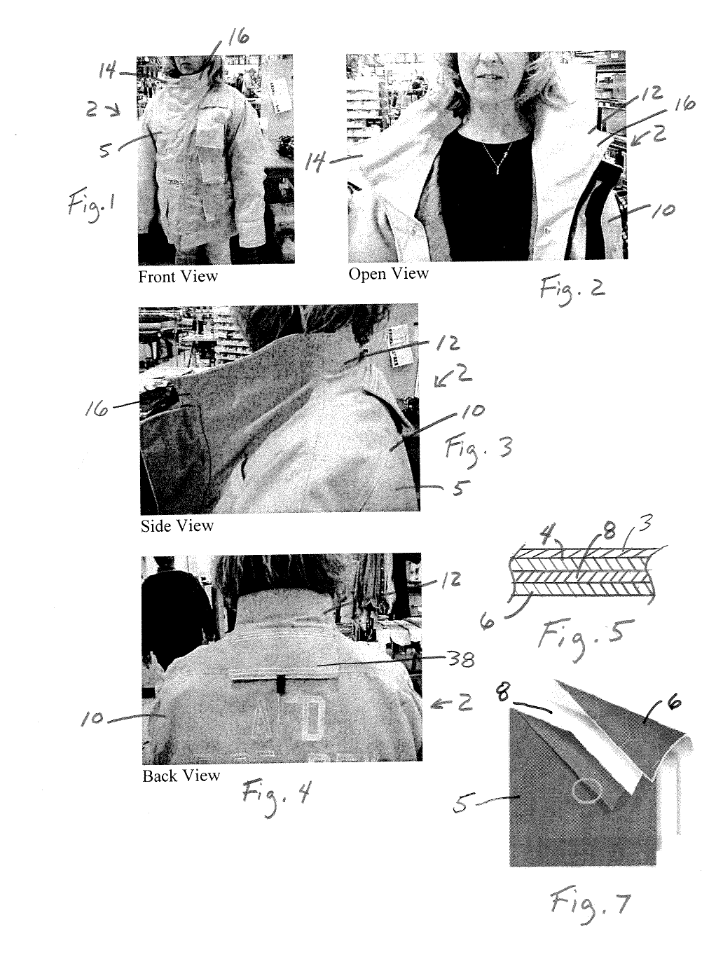

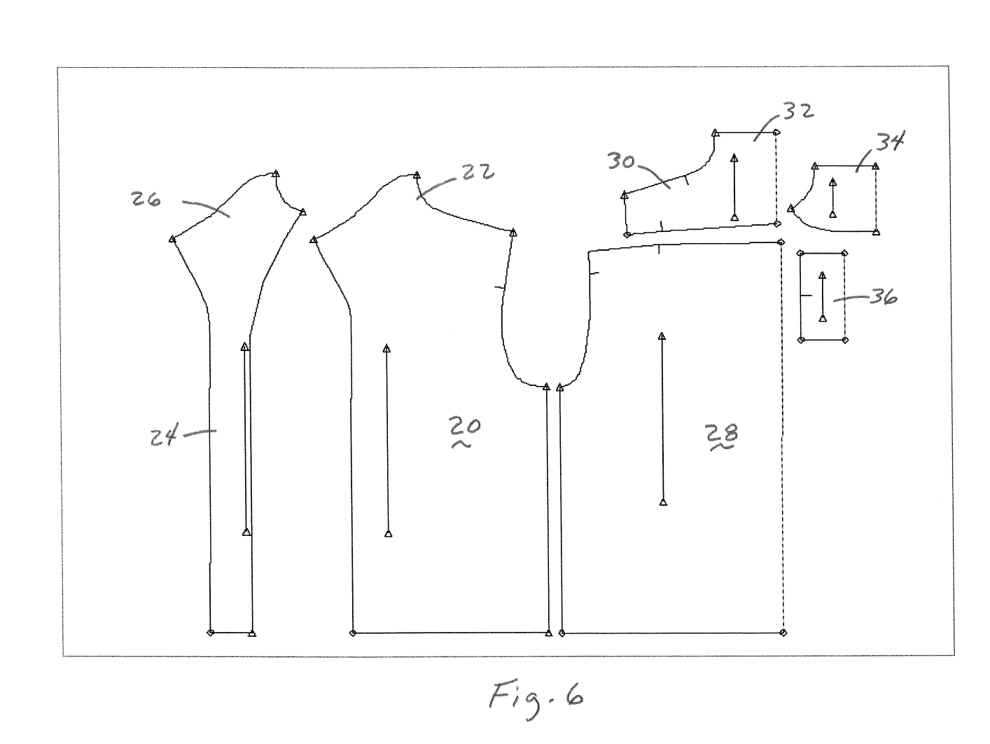

An embodiment 2 of the inventive improved firefighter's turnout coat is illustrated in FIGS. 1-5. The inventive turnout coat 2 comprises a coat body 10 having a collar 12 integrally formed therewith as an extension of the coat body 10 such that there is no stitched collar seam connecting the collar 12 to the coat body 10. The coat body 10 and the collar 12 each preferably comprise: an outer shell 5 formed of two shell layers 3 and 4; an inner thermal liner 6; and a moisture barrier 8 positioned between the outer shell 5 and the thermal liner 6.

As required by the National Fire Protection Association standards, the collar 12 of the inventive coat 2 will stand upright to a required height during use. In addition, the lining system of the inventive coat 2 comprising the thermal liner 6 and the moisture barrier 8 are removable from the outer shell 5 for laundering. In addition, the seamless collar 12 extends forwardly on each side to provide continuous overlapping storm flaps 14 and 16 to protect the firefighter's throat and chin area.

A set of preferred fabric patterns for forming each of the outer shell layers 3 and 4 of the inventive coat 2 is provided in FIG. 6. The patterns comprise: a front coat pattern 20 having an integral collar section 22 extending from the upper end thereof; a front facing pattern 24 having an integral collar section 26 extending from the upper end thereof; a back pattern 28; a back yoke pattern 30 having an integral collar section 32 extending from the upper end thereof; a back collar facing pattern 34; and a pattern 36 for a cover flap 38 which is installed on the back of the shell 5 for covering a drag rescue device.

The thermal liner 6 and the moisture barrier 8 of the inventive coat 2 are also formed using essentially the same patterns shown in FIG. 6 except that a flap for covering a drag rescue device is not needed for or included on either the thermal liner 6 or the moisture barrier 8. Consequently, when formed and stitched together using the fabric patterns shown in FIG. 6, the outer shell 5, the thermal liner 6, and the moisture barrier 8 each separately comprises a body portion 10 and a collar portion 12 which is an integral extension of the body portion 10. Consequently, the outer shell 5, the thermal liner 6, and the moisture barrier 8 are each formed such that there is no stitched collar seam encircling the neck for connecting the collar portion 12 to the body portion 10. Thus, the inventive turnout coat 2 provides continuous, uniform leakage prevention, thermal resistance, and flame resistance throughout the collar area.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the invention as defined by the claims.

What is claimed is:

1. In a firefighter's turnout coat comprising a coat body having a collar extending therefrom which will stand upright during use and said coat body and said collar each comprising an outer shell, a thermal liner, and a moisture barrier between said outer shell and said thermal liner, the improvement comprising said collar being an integral extension of said coat body such that there is no stitched collar seam connecting said collar to said coat body.

2. The firefighter's turnout coat of claim 1 wherein the improvement further comprises said outer shell comprising a body portion and a collar portion which is an integral extension of said body portion of said outer shall such that there is no stitched collar seam connecting said collar portion of said outer shell to said body portion of said outer shell.

3. The firefighter's turnout coat of claim 2 wherein the improvement further comprises said moisture barrier comprising a body portion and a collar portion which is an integral extension of said body portion of said moisture barrier such that there is no stitched collar seam connecting said collar portion of said moisture barrier to said body portion of said moisture barrier.

4. The firefighter's turnout coat of claim 3 wherein the improvement further comprises said thermal liner comprising a body portion and a collar portion which is an integral extension of said body portion of said thermal liner such that there is no stitched collar seam connecting said collar portion of said thermal liner to said body portion of said thermal liner.
